(19) United States
(12) Patent Application Publication
(10) Pub. No.: US 2011/0254311 A1
(43) Pub. Date: Oct. 20, 2011

(54) Door structure module

(75) Inventors: Ulrich DAJEK, Leverkusen (DE); Ralf ZIMNOL, Overath (DE)

(73) Assignee: LANXESS DEUTSCHLAND GMBH, Leverkusen (DE)

(21) Appl. No.: 13/086,888

(22) Filed: Apr. 14, 2011

(30) Foreign Application Priority Data
Apr. 15, 2010 (EP) 10160061.7

(51) Int. Cl. B60J 5/00

(52) U.S. Cl. 296/146.6; 296/146.5

(57) ABSTRACT

The present invention relates to a door structure module, preferably a door structure module for a motor vehicle, particularly preferably a motor vehicle door or a motor vehicle tailgate of metal-plastics-composite design (hybrid technology) and in which at least one panel profile is joined to at least two different plastics elements, where the two plastics elements are composed of different plastics materials which are simultaneously injection-moulded by the bi-injection-moulding process, and as a result of this when the melt fronts of these encounter one another they fuse with one another and simultaneously enter into a secure bond with the panel profile(s).

The present invention relates to a door structure module, preferably a door structure module for a motor vehicle, particularly preferably a motor vehicle door or a motor vehicle tailgate of metal-plastic-composite design (hybrid technology) where at least one panel profile is joined to at least two different plastics elements, where the two plastics elements are composed of different plastics materials which are simultaneously injection-moulded by the bi-injection-moulding process, and as a result of this when the melt fronts of these encounter one another they fuse with one another and simultaneously enter into a secure bond with the panel profile(s).

WO 90/09902 A1 discloses an opening element of a vehicle bodywork encompassing a sheet formed from a metallic part and from a plastics part which has reinforcement ribs and which has been moulded onto the metallic part, where the metallic part is annular and has a U-shaped cross section, and the ribs of the plastics part have been moulded on in the interior of this cross section.

WO 92/12871 A1 discloses a reinforcement structure for a motor vehicle door, where the reinforcement structure has a pair of tubes separated laterally from one another in such a way that, in the event of a lateral impact on the door, one tube is deformed before the other.

WO 97/45283 A1 describes a door module for a motor vehicle, where the door structure has the following: a door cladding with an interior side and with an exterior side, where the interior side has been designed so as to face into a passenger compartment of a motor vehicle, a locking system which has been attached to the external side of the door cladding and which can be activated in order to secure the door structure releasably in a closed position, and a lock which has been attached to the external side of the door cladding and which interacts with the locking system in order to permit selective activation of the locking system.

EP 0 992 380 A1 describes a motor vehicle door of which the supportive frame is composed of a lower plastics part which forms the receptacle for the equipment of the door and of a hollow upper metal part which serves as channel in which the window runs, where the two parts have been combined with one another by comoulding.

WO 2007/111782 A1 describes a door module made of a body which has two sides, where the reinforcement component has been applied on one of the sides of the body and a channel in which the window pane runs has been applied on the other side of the body and has an open profile, and further components can be added to the body via injection moulding.

ATZ November 2005, Volume 107, 1010-1016 “Polycarbonat and seine Blends für Karosseriebauteile” [Polycarbonate and its blends for bodywork components] discloses the use of polycarbonate in multicomponent injection moulding for producing inter alia a tailgate with hybrid support structure.

DE 103 01 520 A1 describes a plastics-metal-composite component made of at least two metallic mouldings which, in overlap regions of the mouldings, with an adhesive, form a coherent bond and which have also been connected to one another via moulded-on thermoplastic, where the mouldings do not have any direct contact with one another, and the adhesive forms an electrically insulating layer between the mouldings.

EP 1 187 734 A1 relates to a vehicle door with a door casing, and also to a process for producing this type of door, where a plastics support part is moulded onto the door inner panel, on the side that faces the external door skin.

A feature common to all of the solutions described in the prior art in relation to motor vehicle door structure modules is that only one plastics component is added to the metallic elements, or, respectively, panels or panel profiles.

A consequence of that type of design: the plastic is selected in accordance with its load limit, so that the design meets requirements. By way of example, plastics structures subject to high loads are reinforced with relatively high glass-fibre content, and this means that the plastic used has relatively high density. However, this high-strength plastic is also used here to produce plastics regions/geometries which are subject to smaller loads or to no mechanical load. Because of the relatively high density/glass-fibre content, this leads to designs that are not weight-optimized, and also increases materials costs or component costs.

Another disadvantage of the motor vehicle door structure modules described in the prior art is the fact that functional elements using a single plastic are moulded onto the door structure module even when the required functions are different. By way of example, in WO 2007/111782 A1 a single plastic, polypropylene, serves for the moulding of the body but also of other possible components, such as air ducts, window motor retainer, map pocket, loudspeaker box, etc., and also for linkage of these to the main body. A single plastic here is assuming not only functions subject to load but also functions which are exposed to no load during the operation of a vehicle.

One way of taking account of exposure of a component to various loads is the use of multicomponent technology. There are various types of multicomponent technology:
Bi-injection, i.e. simultaneous injection of two or more components into the same cavity during the injection-moulding process (see Handbuch Spritzgieβen [Injection moulding handbook], Friedrich Johannaber, Walter Michaeli, Carl Hanser Verlag 2004, in particular Chapter 6.5, pp. 488-491).
Core-back processes, i.e. injection of two or more components in sequence, where the cavity for the 2nd component is made available via withdrawal of a sliding barrier.
Transfer processes, i.e. using a preform which is transferred to a 2nd cavity or 2nd machine before the 2nd component is injected.
Sandwich processes, i.e. layer structure with external skin/core, where the layers are injected in succession.

The object of the present invention therefore consisted in achieving a further weight reduction and cost reduction in comparison with the prior art cited above. A simultaneous intention is to retain, if not actually improve, not only stiffness properties but also crash performance.

Stiffness requirements relate in particular to door overpressure, door torsion, door drop, and bending; the crash requirement relates in particular to frontal crash and side impact, where deformation is not permitted to exceed the permitted maximum, and the structure must withstand a prescribed maximum load before any permanent deformation occurs.

The object is achieved via the following, which is therefore provided by the present invention: a door structure module, preferably a door structure module for a motor vehicle, particularly preferably a motor vehicle door or a motor vehicle tailgate of metal-plastic-composite design (hybrid technology) where at least one panel profile is joined to at least two different plastics elements, where the two plastics elements are composed of different plastics materials which are simultaneously injection-moulded by the bi-injection-moulding process, and as a result of this when the melt fronts of these encounter one another they fuse with one another and simultaneously enter into a secure bond with the panel profile(s). The door structure module preferably takes the form of a frame or is annular.

In one preferred embodiment, the present invention provides a motor vehicle door structure module which is of plastics-metal-hybrid design and which encompasses at least one main body made of at least one panel profile, preferably made of metal or of a high-strength plastics material, where the main body has been locally surrounded by plastic and, as structural element which takes the form of a frame or is annular, connects the hinge regions to the lock region, characterized in that by way of the use of at least two different plastics moreover linkage elements for functional elements are moulded on, and the various plastics materials can give a secure bond between the various plastics parts, in that when the various plastics materials or melt fronts of these encounter one another during the bi-injection-moulding process they fuse with one another and simultaneously enter into a secure bond with the panel profile(s). According to the invention, bi-injection merely means the simultaneous injection of at least two plastics components. An unambiguous feature here is that both, or all of, the melt fronts of the plastics to be injection-moulded have not solidified when they encounter one another, and that their spread is not restricted by any technical features of the moulding process, for example slides or mould cores.

Surprisingly, the door structure modules produced according to the invention, produced via simultaneous injection of the plastics components by the bi-injection-moulding process, exhibit strength of the confluence zone of both, or of all of, the plastics which is at least as high as the flow line strength of a conventional component composed of a single plastic.

The bond strengths are markedly greater than would be expected on the basis of the prior art and moreover the structure of the mould is simpler because there is no need for any mould cores or slides which require separate activation. Instead of this, a “contact zone” of the plastics components is obtained, and is not subject to any precise restriction by technical factors of the moulding process, but instead is determined by way of the relative positioning of the gating for the various components, and by the process parameters. The two injection assemblies can by way of example inject at different rates or else with a time shift, in order to inject more of one of the components or more of the other other component, with resultant controlled displacement of the “contact zone”. When the melt fronts encounter one another here they are in molten condition.

For the purposes of the present application, the panel profiles are preferably structural elements made of the following metals: steel, aluminium or magnesium.

However, according to the invention the expression panel profile also encompasses the expressions panel insert or simply just panel(s).

Further, in an alternative preferred embodiment according to the invention, the expression panel profiles also encompasses high-strength plastics materials, known as organopanels. Organopanels are fundamentally semifinished products that take the form of a sheet made of fibre-reinforced plastic, where these are processed via a shaping mould to give an organopanel profile. By way of example, DE 10 2006 013 685 A1 or DE 10 2004 060 009 A1 describes organopanels to be used according to the invention, and also a process for their production.

Surprisingly, the door structure module of metal-multi-component plastics-composite design according to the invention meets the stiffness requirements, and also the crash requirements, with a weight saving of from 10% to 33%.

In one preferred embodiment, the door structure module produced in the injection-moulding procedure includes reinforcement ribs made from one of the at least two different plastics to be used. The location of the said reinforcement ribs is preferably in the regions where screw threads are used to attach the door hinges (in the structural element that takes the form of a frame), in the regions of transition (frontal and rear) from the structural element that takes the form of a frame to the channel strips, or else in the region of the positions of linkage of the side-impact support to the structural element that takes the form of a frame (frontal and rear). The following are also securely anchored within the door structure module via reinforcement ribs: the drive and the deflector rollers for the window lifter, and also the inner door panels.

In another preferred embodiment, also in the regions not mentioned within the structural element that takes the form of a frame, in the channel strips, and in the side-impact support, there are further supportive ribs made of a second, preferably lower-strength, plastic, where these, on the basis of their supportive function, are designed in a plastic that has lower strength, and thus buttress the thin-walled panel to inhibit premature collapse/buckling under load.

The reinforcement ribs and supportive ribs in turn preferably have secure bonding to the panel profile at discrete connection sites by way of perforations in the panel profile, where the plastic extends through these perforations and across the areas of the perforations.

In one preferred embodiment, the door structure module is composed of a metal plate in the form of a ring and of a moulded-on plastics part. The two together form an element of the internal structure of the door structure module, where the plastics part not only provides a route to the interior design and the processing of the opening element but also permits the linkage of functional elements by way of appropriately, simultaneously and concomitantly moulded-on functional devices. This concept can give a structurally homogeneous arrangement, a perfectly leak-proof system, and also simultaneously the possibility of assuming one or more additional functions.

The invention preferably provides a door structure module with a sheet which has been formed from a metallic part and from a plastics part which has stiffening structures and which has been moulded onto the metallic part, characterized in that the metallic part and the plastics part form an interior structural element of the door structure module, where an exterior sheet has been applied on the said interior structural element, and in that the metallic part has an annular shape which delimits an opening and has a U-shaped cross section, and the reinforcement ribs have been moulded on within the interior of the said part, where these ribs are retained via anchoring points which have been provided on the metallic part, and in that the plastics part has a plate which closes the opening of the metallic part through which it is visible from the inner side of the opening element.

According to one preferred embodiment, the metallic part has the shape of a right-angled trapezium which has an inner arm which connects the right angle in the vicinity of the large base to the opposite side.

According to another property preferred according to the invention, there are, welded onto the plastics part, internal structures which are made of thermoplastic material and which serve to cover the contours of the metallic part.

Further properties and advantages are apparent from the detailed description of the figures below, these serving exclusively as examples.

In one preferred embodiment of the present invention, the panel profile used for the door structure module, and/or the metallic part, has been coated with adhesion promoter or adhesive. Adhesion promoters to be used according to the invention are disclosed in DE 10 2006 025 745 A1, the entire content of which in this connection is incorporated into the present application by way of reference. The adhesion promoter or adhesive is preferably a two-stage adhesion promoter which crosslinks completely in two successive steps, preferably via thermal activation. The adhesion promoter or adhesive can be applied to the panel profile or metal material prior to the punching and/or shaping process, etc. This type of application is preferably achieved in what is known as the coil-coating process, onto the panel profile prior to mechanical operations on the same. This process is particularly cost-efficient. However, it is also possible to apply the adhesion promoter or adhesive via powder spraying or other spraying processes, or dip-coating, etc. Once it has been applied to the panel profile and/or metal tube it is partially crosslinked in a first step, so that the surface formed is dry to the touch and has adequate resistance to damage caused by handling. The adhesion promoter or adhesive is crosslinked completely during or after the moulding-on of the plastic, and thus obtains its final properties. In order to achieve the necessary activation energy for the second phase of the crosslinking of the adhesion promoter, it can be advantageous to heat the plastics mould and/or the panel profile insert or the metallic main body, preferably the metal tube, and/or to inject the plastics material at a sufficiently high temperature into the injection mould, in order to bring about crosslinking. An alternative possibility achieves complete crosslinking through heat-conditioning after the moulding-on process.

The adhesion promoter or adhesive which provides the coherent linkage between plastic and metallic part is preferably a polyurethane system or an epoxy system, particularly preferably an epoxy resin based on bisphenol A and/or on bisphenol B and/or on bisphenol C and/or on bisphenol F.

Preferred adhesion promoter systems or adhesives for the plastics materials to be used according to the invention are based on elastomer-modified epoxy adhesives, in particular with covalent linkage via copolymerization of 1,3-butadienenes and/or with physical binding via addition of rubber.

In an alternative, preferred embodiment, in a separate process step, only after the overmoulding process, the panel profile is connected to the plastics structure via hot-riveting or other types of riveting, pinching, adhesive bonding, or a screw-thread method, and this connection is additional to the bond which involves the panel profile and which always results from the injection-moulding procedure.

The door structure module according to the invention has at least one receptacle moulded-on from a plastic or at least one linkage element for functional elements. Linkage elements preferably to be provided according to the invention via injection moulding serve to retain functional elements from the group of inner door handle, door opener, door lock, window lifter motor, map pockets, ventilation ducts, operating unit for window lifter and mirror adjustment, retainer for external mirror/mirror triangle, internal door cladding, fastening system for external panelling, side-impact support, side airbag, knee protectors, receptacles for loudspeakers. The functional elements mentioned are merely a few examples. In the case of all the receptacles or linkage elements mentioned, where these can have been moulded alternatively or in any desired combination with one another onto the door structure module in a one-piece system, the mounting of various cockpit components is facilitated. However, according to the invention these are moulded from a plastic other than the plastic to be used for the rib reinforcement. According to the invention, it is also possible that the various functional elements are themselves produced from different plastics.

Further functional properties and advantages are apparent from the detailed description of the figures, these serving exclusively as examples.

The plastics used to achieve the rib structure, and also to achieve linkage elements, comprise thermoplastic polymers, preferably in the form of polymer moulding compositions.

According to the invention, at least two different plastics are simultaneously securely bonded via injection moulding both to the main body and to one another, by the bi-injection-moulding process. The bi-injection-moulding process is known to the person skilled in the art. By way of example for the use of the bi-injection-moulding process in automobile construction, reference may be made to WO 2006/003 325 A1.

For reasons of clarity, the description below assumes two thermoplastics, but this does not prevent the present invention from encompassing combinations of larger numbers of plastics.

The present invention preferably provides a door structure module in which the fusion of the two plastics during the bi-injection-moulding process takes place within the cavity where they encounter one another.

Plastics to be injection-moulded are preferably thermoplastic polymers, particularly preferably thermoplastic polymers from the group of the polyamide or polyester or polypropylene and any possible mixture of the abovementioned polymers.

For the purposes of the present invention, the expression a number of plastics or the expression different plastics means at least two different plastics, where the expression different plastics means polymers from the abovementioned group and also plastics based on the same polymer but having different content of filler and/or of reinforcing material.

Processes for producing the thermoplastics to be used according to the invention are known to the person skilled in the art. The effects to be achieved are equally apparent with all of the variations known from the prior art cited above for the use of hybrid technology, irrespective of whether the plastics part completely sheaths the metal part or whether, as in the case of EP 1 380 493 A2, it merely surrounds the same, and irrespective of whether the plastics part is incorporated by subsequent adhesive bonding or is bonded by, for example, a laser to the metal part, or, as in WO 2004/071741, plastics part and metal part obtain the secure interlock bond in an additional operation.

For the purposes of the present invention, “various thermoplastics” are not merely plastics which differ in their chemical structure, but also plastics which are based on the same polymer but of which one has lower content of filler or of reinforcing material and the other has higher content of filler or of reinforcing material.

One embodiment of the present invention therefore also provides door support modules in the manner described above, where the plastics material of the first plastics part differs from the plastic of the second plastics part via the content of fillers and/or of reinforcing materials. However, according to the invention any of the abovementioned polymers can be provided with fillers and/or with reinforcing materials.

In every case, if the same polymer is used, the amount of filler in the plastics to be used is different. However, if different polymers are used, the quantitative proportions present in the two plastics can certainly be identical.

If the same thermoplastic is used in both plastics, the difference in filler content of the two thermoplastics is from 0:70 to 70:0 parts by weight, preferably from 15:65 to 65:15 parts by weight, particularly preferably from 30:60 to 60:30 parts by weight.

Polyamides to be used with preference according to the invention are semicrystalline polyamides (PA), where these can be produced starting from diamines and from dicarboxylic acids and/or from lactams having at least 5 ring members, or from corresponding amino acids. Starting materials that can be used for this purpose are aliphatic and/or aromatic dicarboxylic acids such as adipic acid, 2,2,4- and 2,4,4-trimethyladipic acid, azelaic acid, sebacic acid, isophthalic acid, terephthalic acid, aliphatic and/or aromatic diamines, e.g. tetramethylenediamine, hexamethylenediamine, 1,9-nonanediamine, 2,2,4- and 2,4,4-trimethylhexamethylenediamine, the isomeric diaminodicyclohexylmethanes, diaminodicyclohexylpropanes, bisaminomethylcyclohexane, phenylenediamines, xylylenediamines, aminocarboxylic acids, e.g. aminocaproic acid, and, respectively, the corresponding lactams. The materials include copolyamides made of a number of the monomers mentioned.

Polyamides preferred according to the invention are those produced from caprolactams, very particularly preferably from ε-caprolactam, and also the compounded materials that are mostly based on PA6, on PA66, and on other aliphatic and/or aromatic polyamides or, respectively, copolyamides, where these compounded materials have from 3 to 11 methylene groups for each polyamide group in the polymer chain.

Semicrystalline polyamides to be used according to the invention can also be used in a mixture with other polyamides and/or with other polymers.

Conventional additives, preferably mould-release agents, stabilizers and/or flow aids, can be admixed in the melt with the polyamides or applied to the surface of the polyamides.

Polymers to be used with equal preference according to the invention are polyesters based on aromatic dicarboxylic acids and on an aliphatic or aromatic dihydroxy compound.

A first group of preferred polyesters is provided by polyalkylene terephthalates, in particular those having from 2 to 10 carbon atoms in the alcohol moiety.

These polyalkylene terephthalates are described in the literature. They comprise an aromatic ring within the main chain, and this ring derives from the aromatic dicarboxylic acid. The aromatic ring can have substitution, preferably by halogen, in particular chlorine and bromine, or by C₁-C₄-alkyl groups, in particular methyl, ethyl, isopropyl or n-propyl, and n-butyl, isobutyl or tert-butyl groups.

These polyalkylene terephthalates can be produced via reaction of aromatic dicarboxylic acids, of their esters or other ester-forming derivatives, with aliphatic dihydroxy compounds in any known manner.

Preferred dicarboxylic acids which may be mentioned are 2,6-naphthalenedicarboxylic acid, terephthalic acid, and isophthalic acid, and mixtures thereof. Up to 30 mol %, preferably not more than 10 mol %, of the aromatic dicarboxylic acids can be replaced by aliphatic or cycloaliphatic dicarboxylic acids, such as adipic acid, azelaic acid, sebacic acid, dodecanedioic acids, and cyclohexanedicarboxylic acids.

Among the aliphatic dihydroxy compounds, preference is given to diols having from 2 to 6 carbon atoms, in particular 1,2-ethanediol, 1,3-propanediol, 1,4-butanediol, 1,6-hexanediol, 1,4-hexanediol, 1,4-cyclohexanediol, 1,4-cyclohexanedimethanol and neopentyl glycol, and mixtures of these.

Polyesters whose use is very particularly preferred are polyalkylene terephthalates derived from alkanediols having from 2 to 6 carbon atoms. Among these, particular preference is given to polyethylene terephthalate (PET), polypropylene terephthalate and polybutylene terephthalate (PBT), and mixtures of these. Preference is also given to PET and/or PBT which comprise, as other monomer units, up to 1% by weight, preferably up to 0.75% by weight, of 1,6-hexanediol and/or 2-methyl-1,5-pentanediol.

The viscosity number of polyesters whose use is preferred according to the invention is generally in the range from 50 to 220, preferably from 8 to 160 (measured in 0.5% strength by weight solution in a phenol/o-dichlorobenzene mixture in a ratio by weight of 1:1 at 25° C.) in accordance with ISO 1628.

Particular preference is given to polyesters whose carboxy end group content is up to 100 meq/kg of polyester, preferably up to 50 meq/kg of polyester and in particular up to 40 meq/kg of polyester. Polyesters of this type may be prepared, for example, by the process of DE-A 44 01 055. The carboxy end group content is usually determined by titration methods (e.g. potentiometry).

If polyester mixtures are used, the moulding compositions comprise a mixture composed of polyesters, that is additional polyesters which differ from PBT, an example being polyethylene terephthalate (PET).

Other materials that are used advantageously are recyclates, for example PA recyclates or PET recyclates (also termed scrap PET), if appropriate, in a mixture with polyalkylene terephthalates, such as PBT.

Recyclates are generally:
1) those known as post-industrial recyclates: these are production wastes during polycondensation or sprues from injection moulding obtained during processing, start-up material from injection moulding or extrusion, or edge trims from extruded sheets or foils.
2) post-consumer recyclates: these are plastic items which are collected and treated after utilization by the end consumer. Blow-moulded PET bottles for mineral water, soft drinks and juices are easily the predominant items in terms of quantity.

Both types of recyclate may be used either as ground material or in the form of pellets. In the latter case, the crude recyclates are separated and purified and then melted and pelletized using an extruder. This usually facilitates handling and free flow, and metering for further steps in processing.

The recyclates used may be either pelletized or in the form of regrind. The edge length should not be more than 10 mm, preferably less than 8 mm.

Because polyesters undergo hydrolytic cleavage during processing (due to traces of moisture) it is advisable to predry the recyclate. The residual moisture content after drying is preferably <0.2%, in particular <0.05%.

Another group that may be mentioned of polyesters whose use is preferred is that of fully aromatic polyesters derived from aromatic dicarboxylic acids and aromatic dihydroxy compounds.

Suitable aromatic dicarboxylic acids are the compounds previously described for the polyalkylene terephthalates. The mixtures preferably used are composed of from 5 to 100 mol % of isophthalic acid and from 0 to 95 mol % of terephthalic acid, in particular mixtures of about 80% of terephthalic acid with 20% of isophthalic acid up to approximately equivalent mixtures of these two acids.

The aromatic dihydroxy compounds preferably have the general formula (I)

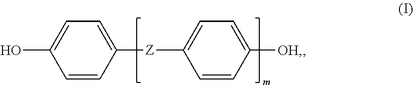

where
Z is an alkylene or cycloalkylene group having up to 8 carbon atoms, an arylene group having up to 12 carbon atoms, a carbonyl group, a sulphonyl group, an oxygen or sulphur atom, or a chemical bond, and where
m is from 0 to 2.

The phenylene groups of the compounds may also have substitution by C₁-C₆-alkyl or -alkoxy groups and fluorine, chlorine or bromine.

Examples of parent compounds for these compounds are dihydroxybiphenyl, di(hydroxyphenyl)alkane, di(hydroxyphenyl)cycloalkane, di(hydroxyphenyl)sulphide, di(hydroxyphenyl)ether, di(hydroxyphenyl)ketone, di(hydroxyphenyl)sulphoxide, α,α′-di(hydroxyphenyl)dialkylbenzene, di(hydroxyphenyl)sulphone, di(hydroxybenzene)benzene, resorcinol, and hydroquinone, and also the ring-alkylated and ring-halogenated derivatives of these.

Among these, preference is given to 4,4′-dihydroxybiphenyl, 2,4-di(4′-hydroxyphenyl)-2-methylbutane, α,α′-di(4-hydroxyphenyl)-p-diisopropylbenzene, 2,2-di(3′-methyl-4′-hydroxyphenyl)propane, and 2,2-di(3′-chloro-4′-hydroxyphenyl)propane, and in particular to 2,2-di(4′-hydroxyphenyl)propane, 2,2-diphenone 4,4′-dihydroxydiphenyl sulphone and 2,2-di(3′,5′-dimethyl-4′-hydroxyphenyl)propane and mixtures of these.

It is, of course, also possible to use mixtures of polyalkylene terephthalates and fully aromatic polyesters. These generally comprise from 20 to 98% by weight of the polyalkylene terephthalate and from 2 to 80% by weight of the fully aromatic polyester.

It is, of course, also possible to use polyester block copolymers, such as copolyetheresters. Products of this type are known and are described in the literature, e.g. in U.S. Pat. No. 3,651,014. Corresponding products are also available commercially, e.g. Hytrel® (DuPont).

According to the invention, halogen-free polycarbonates are also materials to be used with preference as polyesters. Examples of suitable halogen-free polycarbonates are those based on diphenols of the general formula (II)

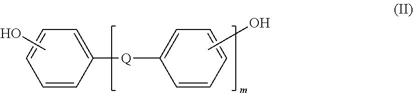

where
Q is a single bond, a C₁-C₈-alkylene, C₁-C₃-alkylidene or C₃-C₆-cycloalkylidene group, or a C₆-C₁₂-arylene group, or —O—, —S— or —SO₂—, and m is a whole number from 0 to 2.

The phenylene radicals of the diphenols may also have substituents, such as C₁-C₆-alkyl or C₁-C₆-alkoxy.

Examples of preferred diphenols of the formula (II) are hydroquinone, resorcinol, 4,4′-dihydroxybiphenyl, 2,2-bis(4-hydroxyphenyl)propane, 2,4-bis(4-hydroxyphenyl)-2-methylbutane and 1,1-bis(4-hydroxyphenyl)cyclohexane. Particular preference is given to 2,2-bis-(4-hydroxyphenyl)propane and 1,1-bis(4-hydroxyphenyl)cyclohexane, and also to 1,1-bis-(4-hydroxyphenyl)-3,3,5-trimethylcyclohexane.

Either homopolycarbonates or copolycarbonates are suitable, and preference is given to the copolycarbonates of bisphenol A, as well as to bisphenol A homopolymer.

Suitable polycarbonates may be branched in a known manner, specifically and preferably by incorporating from 0.05 to 2.0 mol %, based on the total of the diphenols used, of at least trifunctional compounds, for example those having three or more phenolic OH groups.

Polycarbonates which have proven particularly suitable have relative viscosities ηᵣₑₗ of from 1.10 to 1.50, in particular from 1.25 to 1.40. This corresponds to average molar masses M_{w} (weight-average) of from 10 000 to 200 000 g/mol, preferably from 20 000 to 80 000 g/mol.

The diphenols of the general formula are known or can be prepared by known processes.

The polycarbonates may, for example, be prepared by reacting the diphenols with phosgene in the interfacial process, or with phosgene in the homogeneous-phase process (known as the pyridine process), and in each case the desired molecular weight may be achieved in a known manner by using an appropriate amount of known chain terminators. (In relation to polydiorganosiloxane-containing polycarbonates see, for example, DE-A 33 34 782.)

Examples of suitable chain terminators are phenol, p-tert-butylphenol, or else long-chain alkylphenols, such as 4-(1,3-tetramethylbutyl)phenol as in DE-A 28 42 005, or monoalkylphenols, or dialkylphenols with a total of from 8 to 20 carbon atoms in the alkyl substituents as in DE-A-35 06 472, such as p-nonylphenol, 3,5-di-tert-butylphenol, p-tert-octylphenol, p-dodecylphenol, 2-(3,5-dimethylheptyl)phenol and 4-(3,5-dimethylheptyl)phenol.

For the purposes of the present invention, halogen-free polycarbonates are polycarbonates composed of halogen-free diphenols, of halogen-free chain terminators and, if used, halogen-free branching agents, where the content of subordinate amounts at the ppm level of hydrolysable chlorine, resulting, for example, from the preparation of the polycarbonates with phosgene in the interfacial process, is not regarded as meriting the term halogen-containing for the purposes of the invention. Polycarbonates of this type with contents of hydrolysable chlorine at the ppm level are halogen-free polycarbonates for the purposes of the present invention.

Other suitable thermoplastic polymers that may be mentioned are amorphous polyester carbonates, where during the preparation process phosgene has been replaced by aromatic dicarboxylic acid units, such as isophthalic acid and/or terephthalic acid units. Reference may be made at this point to EP-A 0 711 810 for further details.

EP-A 0 365 916 describes other suitable copolycarbonates having cycloalkyl radicals as monomer units.

It is also possible for bisphenol A to be replaced by bisphenol TMC. Polycarbonates of this type are obtainable from Bayer AG with the trademark APEC HT®.

In another preferred embodiment of the present invention, at least one of the polymers or polymer moulding compositions to be used comprises from 0.001 to 75 parts by weight, preferably from 10 to 70 parts by weight, particularly preferably from 20 to 65 parts by weight, with particular preference from 30 to 65 parts by weight, of a filler or reinforcing material.

The filler or reinforcing material used can also comprise a mixture of two or more different fillers and/or reinforcing materials, preferably based on talc, mica, silicate, quartz, titanium dioxide, wollastonite, kaolin, amorphous silicas, magnesium carbonate, chalk, feldspar, barium sulphate, glass beads and/or fibrous fillers and/or reinforcing materials based on carbon fibres and/or glass fibres. It is preferable to use mineral particulate fillers based on talc, mica, silicate, quartz, titanium dioxide, wollastonite, kaolin, amorphous silicas, magnesium carbonate, chalk, feldspar, barium sulphate and/or glass fibres. It is particularly preferable to use mineral particulate fillers based on talc, wollastonite, kaolin and/or glass fibres, very particular preference being given to glass fibres.

Particular preference is moreover also given to the use of acicular mineral fillers. According to the invention, the term acicular mineral fillers means a mineral filler having pronounced acicular character. Those that may preferably be mentioned are acicular wollastonites, especially those for which the length:diameter ratio is preferably from 2:1 to 35:1, particularly preferably from 3:1 to 19:1, with particular preference from 4:1 to 12:1. The average particle size, determined using a CILAS GRANULOMETER, of the acicular minerals to be used inventively is preferably smaller than 20 μm, particularly preferably smaller than 15 μm, with particular preference smaller than 10 μm.

The filler and/or reinforcing material can, if appropriate, have been surface-modified, for example with an adhesion promoter or adhesion-promoter system, for example based on silane. However, this pre-treatment is not essential. However, in particular when glass fibres are used it is also possible to use polymer dispersions, film-formers, branching agents and/or glass-fibre-processing aids, in addition to silanes.

The glass fibres whose use is particularly preferred according to the invention are added in the form of continuous-filament fibres or in the form of chopped or ground glass fibres, their fibre diameter generally being from 7 to 18 μm, preferably from 9 to 15 μm. The fibres can have been provided with a suitable size system and with an adhesion promoter or adhesion promoter system, for example based on silane.

Coupling agents based on silane and commonly used for the pre-treatment are silane compounds, preferably silane compounds of the general formula (III)

(X—(CH₂)_{q})ₖ—Si—(O—CᵣH₂ᵣ₊₁)₄₋ₖ (III)

in which

### X is NH₂—, HO— or

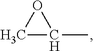

q is a whole number from 2 to 10, preferably from 3 to 4,
r is a whole number from 1 to 5, preferably from 1 to 2 and
k is a whole number from 1 to 3, preferably 1.

Coupling agents to which further preference is given are silane compounds from the group of aminopropyltrimethoxysilane, aminobutyltrimethoxysilane, aminopropyltriethoxysilane, aminobutyltriethoxysilane, and also the corresponding silanes which have a glycidyl group as substituent X.

The amounts generally used of the silane compounds for surface coating for modification of the fillers is from 0.05 to 2% by weight, preferably from 0.25 to 1.5% by weight and in particular from 0.5 to 1% by weight, based on the mineral filler.

As a result of the processing to give the moulding composition or moulding, the d97 value or d50 value of the particulate fillers can be smaller in the moulding composition or in the moulding than in the fillers originally used. As a result of the processing to give the moulding composition or moulding, the length distributions of the glass fibres in the moulding composition or in the moulding can be shorter than those originally used.

If different plastics are used, these can comprise respectively from 0.001 to 70 parts by weight, preferably from 15 to 65 parts by weight, particularly preferably from 30 to 60 parts by weight, with particular preference from 30 to 65 parts by weight, of the fillers individually or in a mixture with other fillers/reinforcing materials.

In every case, if the same polymer is used, the amount of filler in the plastics to be used is different. However, if different polymers are used, the quantitative proportions present in the two plastics can certainly be identical.

If the same thermoplastic polymer is used in both plastics, the difference in filler content of the two thermoplastic polymers is from 0:70 to 70:0 parts by weight, preferably from 15:65 to 65:15 parts by weight, particularly preferably from 30:60 to 60:30 parts by weight.

If the plastic used comprises various thermoplastic polymers, preference is given to combinations from the series of PA-PBT and PA-PP, where PA is polyamide, PBT is polybutylene terephthalate and PP is polypropylene. In one preferred embodiment, the present invention provides the use of at least two different thermoplastic polymers in the production of the door structure module.

In one preferred embodiment, the thermoplastic polymers to be used can comprise at least one compatibilizer, a component material which by way of a physical procedure provides bonding of critical materials, for example polypropylene with polyamide or vice versa. Compatibilizers to be used with preference according to the invention are described by way of example in DE 4 206 191 A1 or U.S. Pat. No. 6,541,571 B1.

Processes according to the invention for producing products via injection moulding operate at melt temperatures in the range from 230 to 330° C., preferably from 250 to 300° C., and also optionally at pressures of at most 2500 bar, preferably at pressures of at most 2000 bar, particularly preferably at pressures of at most 1500 bar and very particularly preferably at pressures of at most 750 bar.

A feature of the injection-moulding process is that the polymer, preferably in the form of pellets, is melted (plastified) in a heated cylindrical cavity and is injected in the form of injection-moulding composition under pressure within a temperature-controlled cavity. After the composition has cooled (solidified), the injection moulding is demoulded.

The different stages are:

### 1. Plastification/melting

2. Injection phase (charging procedure)
3. Hold-pressure phase (because of thermal contraction during crystallization)

### 4. Demoulding.

An injection-moulding machine is composed of a clamping unit, the injection unit, the drive and the control system. Within the clamping unit there are fixed and movable platens for the mould, an end plate, and also tie bars and drive for the movable mould platen. (Articulated lever or hydraulic clamping unit.)

An injection unit encompasses the electrically heatable cylinder, the drive for the screw (motor, gearbox) and the hydraulic system for displacement of the screw and injection unit. The function of the injection unit consists in melting the powder or the pellets and metering and injecting the same and providing hold pressure for the same (because of contraction). The problem of reverse flow of the melt within the screw (leakage flow) is solved by non-return valves.

Within the injection mould, the inflowing melt is then separated and cooled, and the required component is thus manufactured. Two mould halves are always needed for this purpose. The various functional systems used in the injection-moulding process are as follows:
feed system
shaping inserts
deaeration system
machine mounting and uptake of force
demoulding system and transmission of motion
temperature control

The bi-injection-moulding process to be used according to the invention is, in terms of machinery and mould technology, the simplest variant of the two-component injection-moulding process. The two components to be injection-moulded are injected into a cavity by way of two independent injection points, and they encounter one another with varying degrees of definition within the cavity. On closure of the mould, the two units begin to charge material to the cavity. Different screw speeds [cm³/s] can be used to establish the position of the contact zone, i.e. the site at which the melt fronts of the at least two plastics components to be used encounter one another. Symmetrical charging of material to the mould can also be achieved by setting identical volume flow rates.

For clarification, it may be noted that the scope of the invention encompasses all of the definitions and parameters listed above, either in general terms or within preferred ranges, in any desired combination.

### INVENTIVE EXAMPLE

### Brief Description of the Drawings

The invention is described below purely by way of example on the basis of the attached figures:

FIG. 1 shows, in A, the panel insert requiring overmoulding—using appropriate sectional views, and, in B, shows the external view of the finished overmoulded door structure module with moulded-on plastics ribbing, and, in C, the internal view of the same.

FIG. 2 shows the view of a vehicle from inside without add-on parts and cladding parts, but with the following positions provided: 1 for inner door handle, 2 for door opener, 3 for door lock fastening, 4 for arm rest, 5 for map pocket/door storage compartment, 6 for loudspeaker receptacle and 7 for operating unit for window lifter and mirror adjustment.

FIG. 3 shows the external view of a door structure module according to the invention for a vehicle.

The following appropriate retention devices have already been concomitantly moulded onto the system during the injection-moulding process, for the add-on parts and functional elements requiring fastening:
8=mirror triangle/fastening of external mirror
9=reinforcement/screw-thread system for upper door hinge
10=reinforcement/screw-thread system for lower door hinge
11=fastening for window lifter guide system
12=receptacle for window lifter motor
13=receptacle for side-impact support
14=fastening for window lifter guide system

FIG. 4 shows the external view of two sections (A-A and B-B) through the finished door structure module. No additional cladding elements are needed either for the concomitantly moulded-on map pocket region or for the arm rest and the door-pull handle, and suitable surface graining is provided.

FIG. 5 The black arrows indicate the feed positions for the 60% glass-fibre-reinforced nylon-6. The white arrows indicate the feed positions for the 30% glass-fibre reinforced nylon-6.

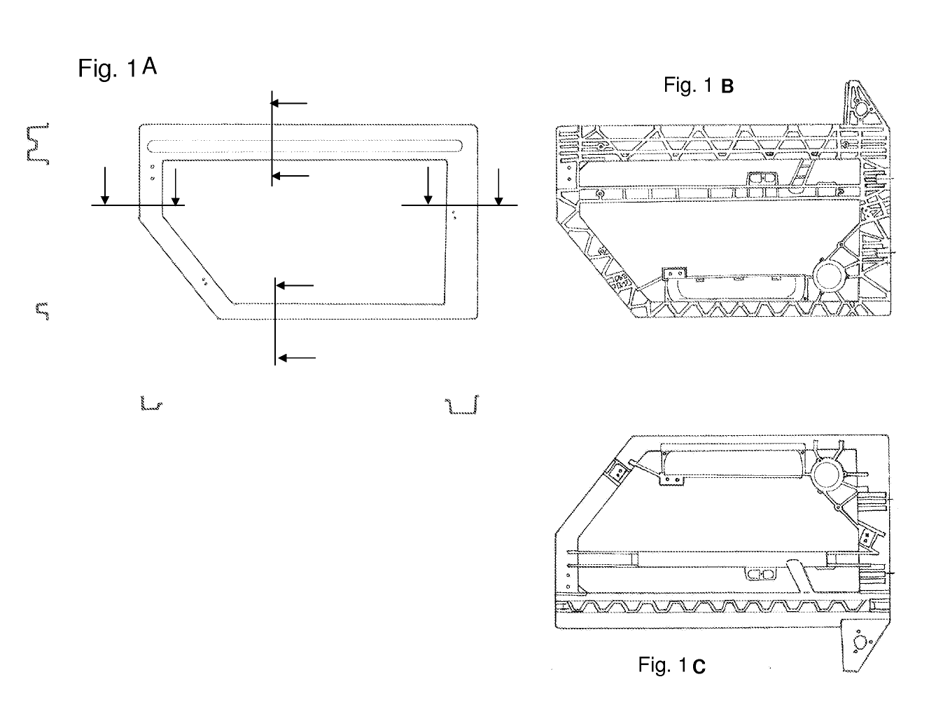

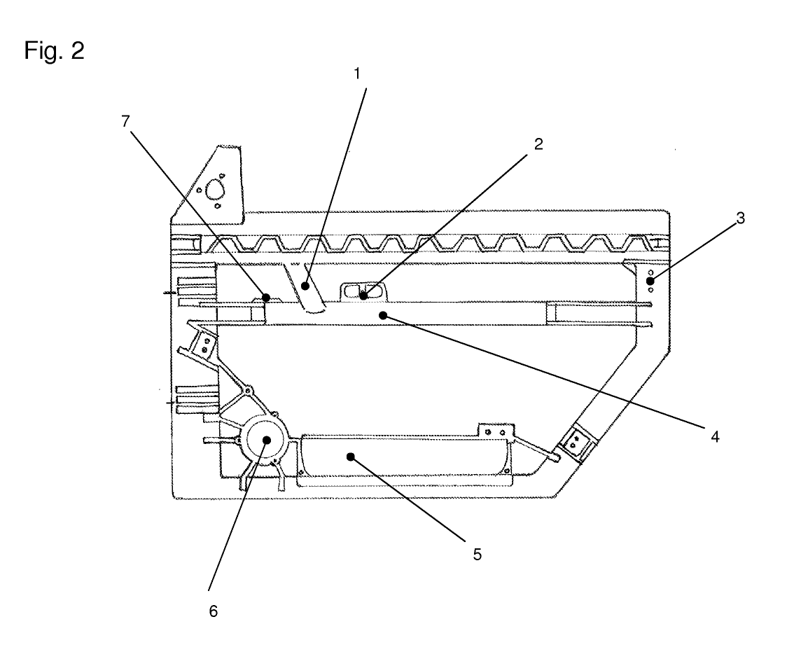

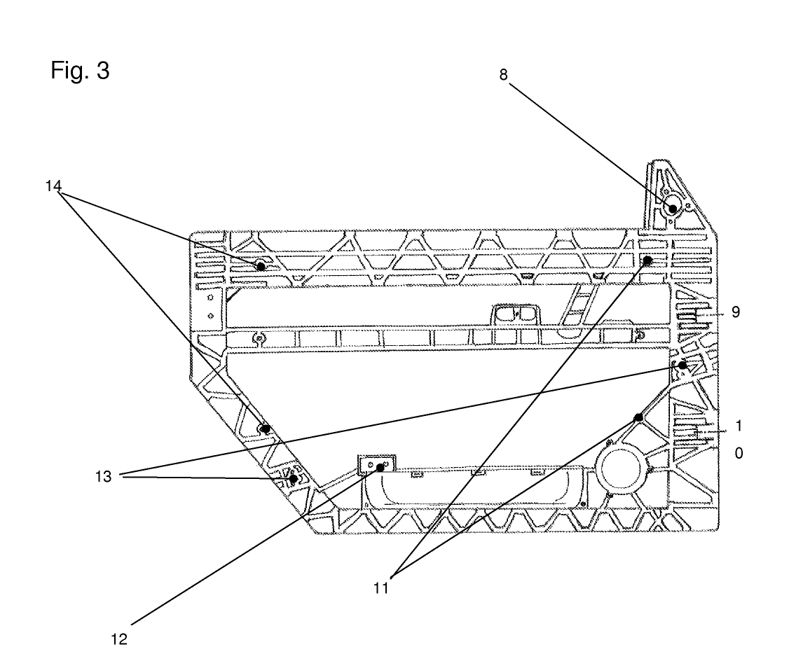

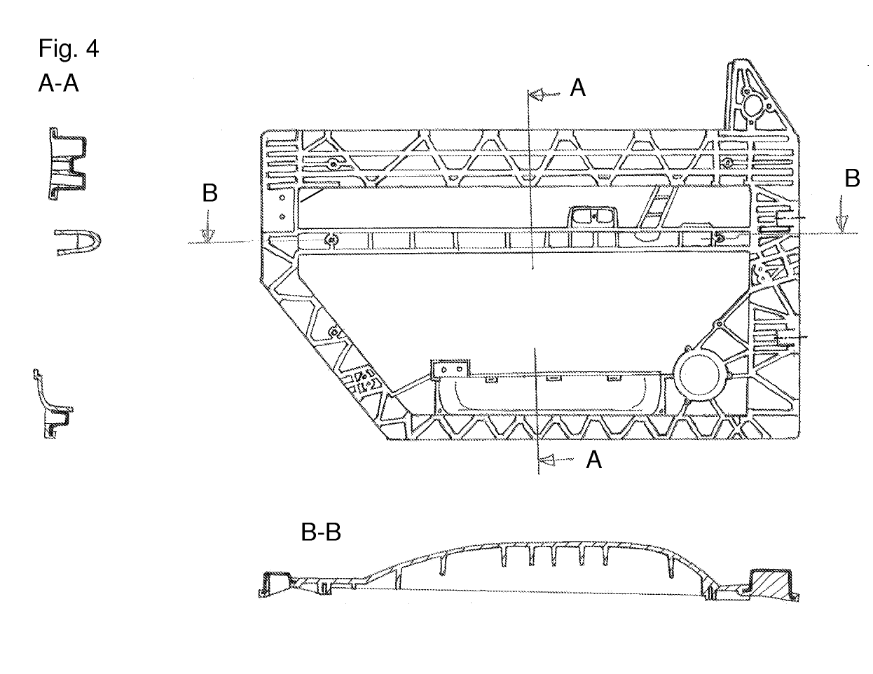

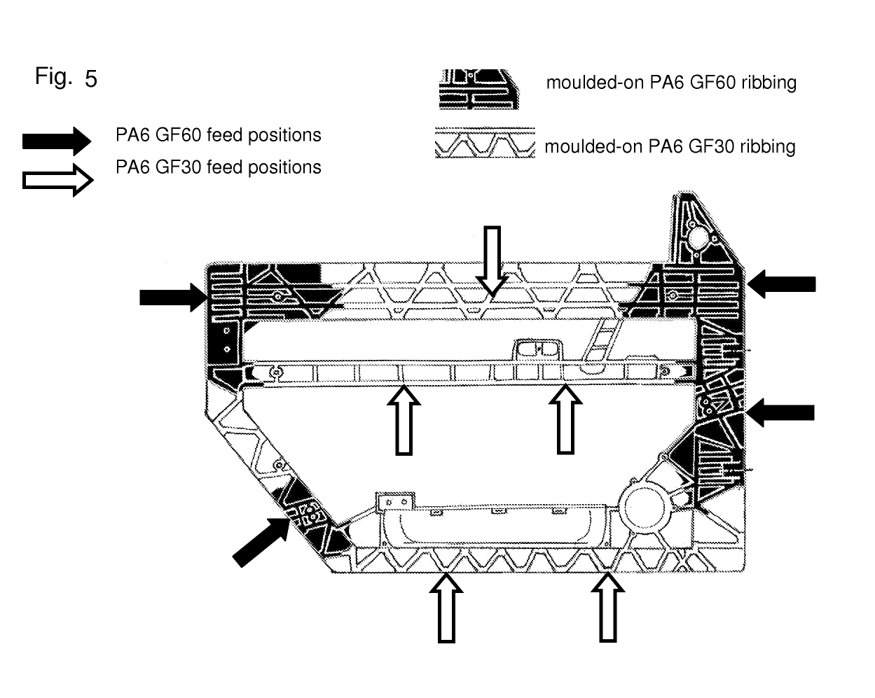

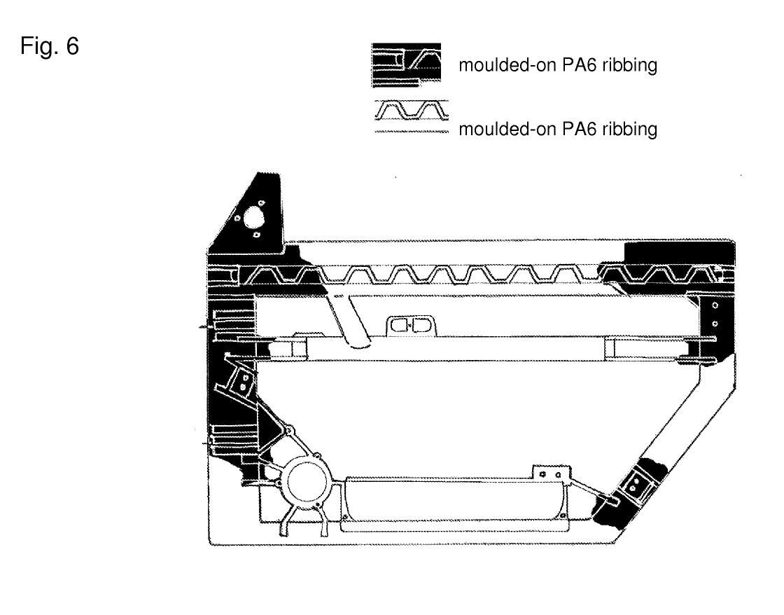

FIG. 5 and FIG. 6 The regions with black background (with white delineating lines) in FIG. 5 and in FIG. 6 indicate the region of the panel insert at which reinforcement ribs and functional elements made of 60% glass-fibre-reinforced nylon-6 have been moulded on. Among these are
the regions for the screw-thread system for the door hinges
the transition regions (frontal and rear) from the structural element that takes the form of a frame to the channel strips
the region of the linkage positions of the side-impact support to the structural element that takes the form of a frame (frontal and rear)
the mirror triangle with the fastening positions for the external mirror
the receptacle for the door lock.

The regions with white background in FIG. 5 and FIG. 6 (with black delineating lines) indicate the region of the panel insert at which reinforcement ribs and functional elements made of 30% glass-fibre-reinforced nylon-6 have been moulded on.

1. Door structure module which is of metal-plastic-composite design (hybrid technology) and in which at least one panel profile is joined to at least two different plastics elements, characterized in that the two plastics elements are composed of different plastics materials which are simultaneously injection-moulded by the bi-injection-moulding process, and as a result of this when the melt fronts of these encounter one another they fuse with one another and simultaneously enter into a secure bond with the panel profile(s).

2. Door structure module according to claim 1, characterized in that this takes the form of a frame or is annular.

3. Door structure module according to claim 1 or 2, characterized in that the plastics structure has reinforcement ribs.

4. Door structure module according to claim 3, characterized in that the reinforcement ribs have secure bonding to the panel profile at discrete connection sites by way of perforations in the panel profile, where the plastic extends through these perforations and across the areas of the perforations.

5. Door structure module according to claims 1 to 4, characterized in that the plastic used comprises thermoplastic polymers.

6. Door structure module according to claim 5, characterized in that thermoplastic polymers used comprise those from the group of the polyamides or polyesters or polypropylene and any possible mixture of the abovementioned polymers.

7. Door structure module according to claim 5 or 6, characterized in that at least one of the thermoplastic polymers comprises from 0.001 to 75 parts by weight of a filler or reinforcing material.

8. Door structure module according to any of claims 1 to 7, characterized in that the panel profile is an organopanel.

9. Door structure module according to any of claims 1 to 8, characterized in that the panel profile and/or the main body has been coated with adhesion promoter or with adhesive.

10. Door structure module according to any of claims 1 to 9, characterized in that, in a separate process step, only after the overmoulding process, the panel profile is connected to the plastics structure via hot-riveting or other types of riveting, pinching, adhesive bonding, or a screw-thread method, and this connection is additional to the bond which involves the panel profile and which always results from the injection-moulding procedure.

11. Door structure module according to any of claims 1 to 10, characterized in that this has at least one receptacle moulded-on from a plastic or at least one linkage element for functional elements.

12. Use of a door structure module according to any of claims 1 to 11 in motor vehicles.
